(19) United States
(12) Patent Application Publication
(10) Pub. No.: US 2012/0270185 A1
(43) Pub. Date: Oct. 25, 2012

(54) DENTAL APPARATUS

(75) Inventors: Mikako Hayashi, Osaka (JP); Shigeyuki Ebisu, Osaka (JP); Atsushi Sugeta, Hiroshima (JP)

(73) Assignees: HIROSHIMA UNIVERSITY, Hiroshima (JP); OSAKA UNIVERSITY, Osaka (JP)

(21) Appl. No.: 13/532,855

(22) Filed: Jun. 26, 2012

Related U.S. Application Data
(62) Division of application No. 12/445,593, filed on Apr. 15, 2009.

(30) Foreign Application Priority Data
Oct. 17, 2006 (JP) 2006-282851
Apr. 13, 2007 (JP) PCT/JP2007/058574

(51) Int. Cl. A61C 19/06; A61C 5/02

(52) U.S. Cl. 433/224

(57) ABSTRACT

The present invention provides a dental apparatus (1) for strengthening a tooth, comprising a heating means (15) for heating the dentin of the tooth. The dental apparatus (1) of the present invention can safely and effectively reinforce a tooth from which the dental pulp has been removed.

### CROSS REFERENCE TO RELATED APPLICATION

The present application is a divisional of and claims priority under 35 U.S.C. §120 to copending U.S. application Ser. No. 12/445,593, filed 15 Apr. 2009, the entirety of which is hereby incorporated herein by reference.

### TECHNICAL FIELD

The present invention relates to a dental apparatus for strengthening a tooth.

### BACKGROUND ART

In dental treatment, a procedure for removing the dental pulp (a procedure that removes the dental nerve) due to progressed dental caries is routinely performed. However, it is known that, in a tooth from which the dental pulp has been removed, a cavity is formed in the central portion of the tooth, and this structural aspect significantly lowers the mechanical strength of the tooth (Reeh et al., J. Endodon, Vol. 15, pp. 512-515, 1989). It is reported that the fracture of a tooth due to such a reduction in the strength is a primary cause of tooth loss (P. Axelsson et al., J. Clin. Periodontal, Vol. 31, pp. 749-757, 2004). In order to reinforce such a tooth, a procedure for providing a support made of a metal, a resin, or the like at the central portion of the tooth in which the dental pulp was present is commonly performed (Yuji Tsubota, Dental Review, Vol. 65, No. 10 (serial number 756), pp. 53-64, 2005).

However, when this sort of procedure is performed by using an artificial material in order to reinforce a tooth from which the dental pulp has been removed, in a case where the tooth and the reinforcing material have different mechanical properties, an excessive stress may be concentrated in the internal portion of the tooth. Accordingly, the tooth may be broken, which may result in extraction of the tooth. Also, there is a concern that a tooth from which the dental pulp has been removed becomes brittle due to dryness. As described above, a method for safely and effectively reinforcing a tooth from which the dental pulp has been removed has not been established yet.

### DISCLOSURE OF INVENTION

It is an object of the present invention to provide a dental apparatus that can safely and effectively reinforce a tooth from which the dental pulp has been removed.

The present inventors found that, when the dentin of a tooth is heated, in particular, to 70° C. to 140° C., the strength of the tooth is significantly increased, and thus the present invention was achieved.

The present invention provides a dental apparatus for strengthening a tooth, comprising a heating means for heating the dentin of the tooth.

In one embodiment, the dentin of the tooth is heated so that a temperature of a surface of the dentin is 70° C. to 140° C.

In one embodiment, the dental apparatus further comprises a temperature-controlling means.

In one embodiment, the dental apparatus further comprises a dental pulp cavity-insertion plug, wherein the dental pulp cavity-insertion plug is heated by the heating means.

In a certain embodiment, the dental apparatus comprises a handpiece portion and a control device,

wherein the handpiece portion comprises a handgrip portion, a protecting tube that is disposed at a front end of the handgrip portion and that partially projects from the front end of the handgrip portion, the dental pulp cavity-insertion plug that passes through the protecting tube so that a front end thereof is outside the protecting tube and a rear end thereof is accommodated in the handgrip portion, a plug front end temperature-measuring means that is disposed at the front end of the plug, a heating means for heating the plug accommodated in the handgrip portion, and a heating switch that is disposed on the outer side of the handgrip portion and that is used for activating the heating means;

the control device comprises a power on-and-off switch and the temperature-controlling means;

the plug front end temperature-measuring means and the heating switch are both connected to the temperature-controlling means, the temperature-controlling means is connected via the power on-and-off switch to the heating means; and

the temperature-controlling means controls a temperature of the heating means based on a temperature measured by the plug front end temperature-measuring means.

In one embodiment, the dental apparatus further comprises a dentin surface temperature-measuring means,

wherein the dentin surface temperature-measuring means is connected to the temperature-controlling means, and the temperature-controlling means controls the temperature of the heating means also based on a temperature measured by the dentin surface temperature-measuring means.

In a certain embodiment, the temperature of the front end of the plug is set so that a temperature of a surface of the dentin is 70° C. to 140° C.

In a further embodiment, the temperature of the front end of the plug is set to 70° C. to 500° C.

In another embodiment, the control device further comprises a plug temperature-display portion.

In a further embodiment, the control device further comprises a dentin surface temperature-display portion.

In a further embodiment, the heating means performs heating using an electric heater, electromagnetic waves, or laser beams.

The present invention also provides a method for strengthening a tooth, comprising a step of heating the dentin of the tooth.

In one embodiment, the dentin of the tooth is heated so that a temperature of a surface of the dentin is 70° C. to 140° C.

In a certain embodiment, the heating step is performed using the dental apparatus.

According to the present invention, a dental apparatus that can safely and effectively reinforce a tooth from which the dental pulp has been removed is provided. With the apparatus of the present invention, a tooth that has become brittle due to the removal of the dental pulp in the treatment of dental caries or the like can be easily strengthened, and the health of a tooth devoid of dental pulp can be maintained for a longer period of time. Accordingly, quality of life is improved.

### BRIEF DESCRIPTION OF DRAWINGS

FIG. 1 is a schematic view illustrating an example of a dental apparatus of the present invention.

FIG. 2 is a graph showing the results of a cantilever bending test performed on rod-like samples taken from human dentin stored in various conditions.

FIG. 3 is a graph showing the results of a micro-tensile test performed on rod-like samples taken from human dentin stored in various conditions.

FIG. 4 is a graph showing the fracture toughnesses of rod-like samples taken from human dentin stored in various conditions.

FIG. 5 is a graph showing the elastic moduli of rod-like samples taken from human dentin stored in various conditions.

FIG. 6 shows X-ray diffraction photographs of rod-like samples taken from human dentin stored in wet and heated conditions.

FIG. 7 is a schematic view showing the center-to-center distance of collagen triple helixes in a sample in a decalcified wet group.

### BEST MODE FOR CARRYING OUT THE INVENTION

First, the principle of the present invention will be described.

A tooth is made of a surface layer structure material comprising enamel, dentin, and cementum. Anatomically, this structure can be divided into a crown comprising dentin and enamel that covers the dentin, and a root comprising dentin and cementum that covers the dentin. The central portion of tooth has a dental pulp cavity that is filled with dental pulp, which is a dental nerve. When the dental pulp, which is a dental nerve, is removed due to dental caries or the like, the dental pulp cavity is exposed as a columnar cavity. The exposed area of the tooth to the dental pulp cavity is made of the dentin.

Dentin comprises approximately 25 vol % of a collagen fiber and approximately 50 vol % of hydroxyapatite. Dentin has a large number of dentinal tubules that run in the direction outward from the dental pulp cavity.

When the dentin is heated, crosslinked structures inside the collagen increase, and the center-to-center distance of the triple helixes of the collagen fibers is reduced. Here, the denaturation temperature of protein is approximately 55° C. to 60° C., and the denaturation temperature of collagen is approximately 105° C. to 110° C. Thus, the density of the collagen meshwork structure in which hydroxyapatite crystals are contained increases, thereby improving the mechanical strength of the tooth. In particular, when the dentin exposed to the dental pulp cavity is heated to 70° C. to 140° C., bending strength, tensile strength, and fracture toughness are significantly improved specifically in the running direction of the dentinal tubules. Accordingly, the tooth can be mechanically strengthened by heating the dentin in the oral cavity.

Hereinafter, a dental apparatus of the present invention will be described with reference to the drawings.

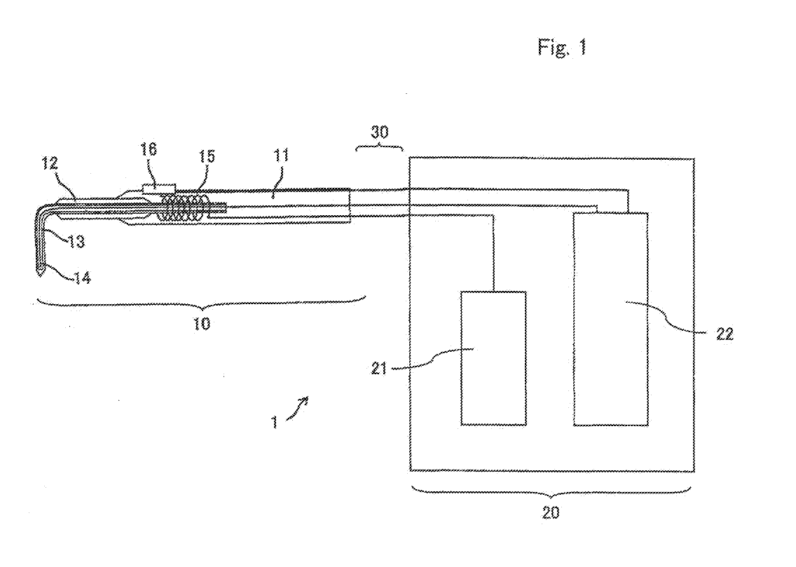

FIG. 1 is a schematic view illustrating an example of the dental apparatus of the present invention. A dental apparatus 1 of the present invention includes a handpiece portion 10 and a control device 20. The control device 20 has a shape of casing, and this casing is connected via a flexible connecting portion 30 to the handpiece portion 10. The handpiece portion 10 of the dental apparatus shown in this example may have any shape as long as it is suitable for heating a tooth. The shape is not limited to a handpiece, and may be a mouthpiece or the like. In this specification, a detailed description will be given using a handpiece-type portion as an example.

As shown in FIG. 1, the handpiece portion 10 includes a handgrip portion 11, a protecting tube 12, a dental pulp cavity-insertion plug 13, a plug front end temperature-measuring means 14, a heating means 15, and a heating switch 16.

The handgrip portion 11 is a portion that is held by a user (e.g., a dentist). The handgrip portion 11 may be designed to have a size and shape that allow a user to easily grip and operate the handgrip portion 11. Considering the fact that the handgrip portion 11 is a portion that is held by a user, it is preferable to employ a structure and material that do not transfer heat generated by the heating means 15 inside the handgrip portion 11, which will be described later. In an example of the structure of the handgrip portion 11, a heat insulating material is disposed on the inner side, and the outer side of the handgrip portion 11 is covered by a material that allows the user to easily hold and operate the handgrip portion 11. More specifically, the handgrip portion 11 is made of, for example, plastic that includes a heat insulating material internally. The handgrip portion 11 is preferably in the shape of a cylinder having a diameter of approximately 3 cm, in view of the ease in gripping.

The protecting tube 12 is a portion that prevents the heated dental pulp cavity-insertion plug 13, which will be described later, from being brought into direct contact with the mouth of a patient, in particular, the lips, the tongue, or the like of a patient. For example, when the protecting tube 12 is provided with the plug 13, the mouth does not have to be kept open throughout the heating time of a tooth. Thus, the patient can close the mouth so as to hold the protecting tube 12 between the teeth. The material of the protecting tube 12 is not particularly limited, but it is preferable to use a material that does not transfer heat, as in the handgrip portion 11. Furthermore, the protecting tube 12 has a size and shape that are convenient for inserting the apparatus into the mouth without giving any sense of discomfort.

The dental pulp cavity-insertion plug 13 is a means that is to be inserted into the dental pulp cavity and heat a tooth (in particular, the dentin). For example, the rear end of the dental pulp cavity-insertion plug 13 is heated by the heating means 15 inside the handgrip portion 11, the heat is transferred to the front end of the plug, thereby heating the dentin. Thus, the dental pulp cavity-insertion plug 13 is preferably made of a material having excellent heat conductivity (e.g., metal). Furthermore, the material may be a material that can be heated to a temperature (e.g., 100° C. to 300° C.) slightly higher than that of the dentin to be heated. Examples of such a material include stainless steel, a gold-platinum alloy, a gold alloy, and the like. Among these, stainless steel is preferable, in view of durability, processability, and cost.

The dental pulp cavity-insertion plug 13 internally includes a connecting means to the plug front end temperature-measuring means and a temperature-controlling means 22 for controlling the temperature of the plug front end as described later. Thus, it is preferable that the dental pulp cavity-insertion plug 13 is in the shape of a hollow needle or tube, and has a closed front end. The outer diameter of the dental pulp cavity-insertion plug 13 is smaller than that of the dental pulp cavity, and is preferably 1 mm to 2 mm. The dental pulp cavity-insertion plug 13 may be in the shape of a straight rod, or may be curved in the shape of an L (hook shape) outside the protecting tube as shown in FIG. 1. The shape is preferably an L-shaped curve, in view of the ease in handling during use. Considering the shape of the dental pulp cavity, the dental pulp cavity-insertion plug 13 preferably has a tapered structure in which the width of the front end projecting outward from the protecting tube 12 is reduced toward the front end.

Furthermore, the number of dental pulp cavity-insertion plugs 13 is not limited to one. For example, in the case of a molar tooth, the dental pulp cavity is divided into three branches, and thus three plugs may be provided so as to respectively correspond thereto. Alternatively, a design may be applied in which one to three plugs 13 can be attached and detached together with the protecting tube 12 at the front end of the handgrip portion 11.

The heating means 15 heats the rear end of the dental pulp cavity-insertion plug 13, that is, a portion accommodated in the handgrip portion 11. In the case of the apparatus in FIG. 1, the heating means 15 is not particularly limited as long as it is a heater that uses electricity as a heat source. For example, a heater commonly used by those skilled in the art, such as a sheath heater that generates heat by resistance heating and is protected from the outside by a sheath made of a metal, may be preferably used.

Alternatively, the heating means 15 may be a heating means that uses electromagnetic waves, laser beams, or the like. In this case, the dental pulp cavity-insertion plug 13 can heat the dentin by emitting electromagnetic waves, laser beams, or the like from a point near its front end toward the dentin.

The heating switch 16 is a switch that is disposed on the outer side of the handgrip portion 11 and that is used for activating the heating means 15. Since the heating switch 16 is disposed at the handgrip portion 11 that is held by a user, the user can easily perform a heating operation during use. The heating switch 16 is connected to a temperature-controlling means 22 disposed in the control device 20, which will be described later, and the temperature-controlling means 22 is connected via a power on-and-off switch 21, which will be described later, to the heating means 15. For example, if the heating switch 16 is turned on at the time of activation, the heating means 15 is connected to the power source, and heating is started. On the other hand, if the heating switch 16 is turned off, the connection to the power source is blocked, and the heating is stopped.

The plug front end temperature-measuring means 14 is disposed at the front end of the dental pulp cavity-insertion plug 13, and measures the temperature of the front end of the dental pulp cavity-insertion plug 13. As the plug front end temperature-measuring means 14, a sensor commonly used by those skilled in the art may be used, as long as it is a temperature sensor having a size that allows it to be disposed inside the front end of the plug 13, and having an ability to measure a temperature of the front end of the plug 13. Examples thereof include various types of thermocouples. The plug front end temperature-measuring means (temperature sensor) 14 is connected to a thermometer in the temperature-controlling means 22. For example, in the case where the temperature sensor 14 is a thermocouple, the connection is made via a lead wire (compensation lead wire) made of a metal having thermo-electromotive force properties substantially similar to that of the thermocouple used.

Although not shown in the figure, the dental apparatus 1 of the present invention preferably includes a dentin surface temperature-measuring means. The dentin surface temperature-measuring means is a temperature sensor having a coated surface. This sensor is inserted into the dental pulp cavity, is brought into contact with the surface of the dentin so as not to be in contact with the plug 13, and measures the temperature of the surface of the dentin. As the temperature sensor, those similar to the plug front end temperature-measuring means 14 described above may be used.

The dentin surface temperature-measuring means may be disposed next to the dental pulp cavity-insertion plug 13 at the front end of the handpiece portion 10, or may be disposed as a probe having only a temperature sensor and a lead wire separately from the handpiece portion 10. It is preferable that the dentin surface temperature-measuring means projects from the protecting tube 12 to be disposed next to the plug 13. In this case, the dentin surface temperature-measuring means has to be thermally insulated from the plug 13 that is heated in the handgrip portion 11 and the protecting tube 12. The dentin surface temperature-measuring means is connected to the thermometer in the temperature-controlling means 22. Furthermore, in the case where the dentin surface temperature-measuring means is disposed next to the plug 13, it is preferable that the means can be moved to adjust its position in the dental pulp cavity so as to be able to bring into contact with the surface of the dentin without being in contact with the plug 13.

As shown in FIG. 1, the control device 20 comprises the power on-and-off switch 21 and the temperature-controlling means 22.

The power on-and-off switch 21 is connected so that the supply of electricity to the heating means 15 can be controlled by the temperature-controlling means 22. The power on-and-off switch 21 controls the supply of electricity from a power source (plug socket) or a battery (if necessary, disposed inside the control device) to the heating means 15.

The temperature-controlling means 22 plays a role in controlling the power on-and-off switch 21, based on the temperature of the front end of the plug 13 measured by the plug front end temperature-measuring means 14, the temperature of the surface of the dentin measured by the dentin surface temperature-measuring means, and the like. Although not shown in the figure, the temperature-controlling means 22 comprises a thermometer, a temperature-setting means, a heating rate-controlling means, and the like.

For example, the thermometer recognizes the temperatures measured by the plug front end temperature-measuring means 14 and the dentin surface temperature-measuring means. The temperature-setting means appropriately sets the temperature range of the front end of the plug 13 and the temperature range of the surface of the dentin. For example, a knob for setting the temperature may be disposed on the surface of the casing of the control device 20. The heating rate-controlling means controls a heating rate so that neither the temperature of the front end of the plug 13 nor the temperature of the surface of the dentin exceeds a preset temperature. All of these constituent elements are controlled by an electronic controller.

When this sort of temperature-controlling means 22 is provided, the plug 13 can be prevented from, for example, being overheated by the heating means 15, and thus the temperature of the front end of the plug 13 can be maintained at an appropriate temperature. Moreover, when the dentin surface temperature-measuring means is provided, such control can be performed based on not only the temperature of the dental pulp cavity-insertion plug 13 that is for heating the dentin but also on the temperature of the surface of the dentin that is to be heated, and thus dental treatment can be performed more safely and more precisely.

Moreover, it is preferable that a plug temperature-display portion, a dentin surface temperature-display portion, and the like are provided on the surface of the casing of the control device 20 for visual confirmation of the temperature of the dental pulp cavity-insertion plug 13 and the temperature of the surface of the dentin. When the display portions are provided, even if the setting of the temperature or the like is incorrectly performed, accidents due to overheating can be prevented because the temperature of each constituent element in use can be visually confirmed with these temperature-display portions.

In addition to the above, a direct-current amplifier, a direct-current converter, and other constituent elements arranged in a commonly used temperature-adjusting apparatus are provided. In a case where a battery is mounted, the dental apparatus becomes portable.

Next, a method for using the dental apparatus 1 of the present invention shown in FIG. 1 will be described. First, the dental apparatus 1 of the present invention is connected to a power source (plug socket) or a battery to allow electricity to flow, thereby making the dental apparatus 1 ready for use. Then, the temperature-setting means (not shown in the figure) disposed in the temperature-controlling means 22 is used to set the temperature of the dental pulp cavity-insertion plug 13. The temperature of the dental pulp cavity-insertion plug 13 is set to preferably 70° C. to 500° C., and more preferably 150° C. to 200° C. This temperature is preferably set so that the temperature of the surface of the dentin is 70° C. to 140° C. In the case where the dentin surface temperature-measuring means is provided, the temperature of the surface of the dentin is also set in this manner. The temperature of the surface of the dentin is set to preferably 70° C. to 140° C., and more preferably 90° C. to 120° C. When the temperature is set to this temperature range, the temperature of the entire dentin is approximately 70° C. to 110° C.

Then, the handgrip portion 11 of the handpiece portion 10 is held, and the dental pulp cavity-insertion plug 13 is inserted into the dental pulp cavity. At that time, the plug 13 is disposed so as to be in direct contact with the dentin. Alternatively, in the case where a thermally conductive and harmless medium is injected in advance into the dental pulp cavity, the plug 13 is disposed so as to be immersed in this medium. Here, examples of the thermally conductive and harmless medium include glycerin and silicone oil. Moreover, in the case where the dentin surface temperature-measuring means is provided, the means is inserted into the dental pulp cavity and disposed so as to be in direct contact with the surface of the dentin.

Then, the heating switch 16 of the handpiece portion 10 is turned on to allow electricity to flow through the heating means 15, and thus heat is generated by the heating means 15. This heat is used to heat the dental pulp cavity-insertion plug 13 to a preset temperature. The temperature of the front end of the dental pulp cavity-insertion plug 13 is measured by the plug front end temperature-measuring means 14, and this information is transmitted to the temperature-controlling means 22. When the temperature of the front end of the dental pulp cavity-insertion plug 13 has become close to the preset temperature, the heating rate-controlling means disposed in the temperature-controlling means 22 is activated to send a signal to suppress heat generation to the heating means 15, and thus heat generation by the heating means 15 is suppressed. Then, when the temperature of the front end of the dental pulp cavity-insertion plug 13 has reached the preset temperature, a signal to stop or suppress heat generation is sent to the heating means 15, and thus the preset temperature is maintained. If necessary, the position of the dental pulp cavity-insertion plug 13 in the dental pulp cavity may be changed in order to uniformly heat the dentin.

The period of time for heating the dentin varies depending on the type or size of a tooth. Typically, the period of time is 10 minutes to 30 minutes, and preferably 10 minutes to 15 minutes. The temperature of the surface of the dentin is measured by the dentin surface temperature-measuring means, and this information is transmitted to the temperature-controlling means 22. When the temperature of the dentin has reached a temperature within a desired preset temperature range, the heating rate-controlling means disposed in the temperature-controlling means 22 is activated to send a signal to suppress heat generation to the heating means 15, and thus heat generation by the heating means 15 is suppressed or stopped. The preset temperature is maintained. After the preset temperature is maintained for a desired period of time, the heating switch 16 of the handpiece portion 10 is turned off to terminate the heating. Subsequently, the dental pulp cavity-insertion plug 13 and the dentin surface temperature-measuring means are taken out of the dental pulp cavity, and carefully removed from the mouth so as not to be brought into contact with the lips or tongue. In the case where the above-described medium is used, the medium is removed from the dental pulp cavity using a given method after the heating.

In this manner, a tooth from which the dental pulp has been removed can be mechanically strengthened by heating the dentin using the dental apparatus of the present invention. For the method for strengthening a tooth by heating, the apparatus of the present invention is preferably used, but other apparatuses and/or means may be used for heating, as long as the dentin can be heated to the predetermined temperature described above.

Examples of other apparatuses and/or means include heating using laser beams. However, since the dentin has a low thermal conductivity, heating using laser beams takes several minutes to heat across the dentin, and thus laser beam irradiation has to be maintained in the dental pulp cavity for several minutes. Accordingly, the dental apparatus of the present invention is more preferably used in view of safety. Furthermore, in a case where a support is provided in the dental pulp cavity in common dental therapy, typically, a probe is heated in order to melt a support material (e.g., a metal and a resin). This sort of probe can be used also to heat the dentin. However, the dental apparatus of the present invention is more preferably used in order to maintain the entire dentin at a predetermined temperature as described above.

### EXAMPLE

Hereinafter, the principle of the method for strengthening a tooth using the dental apparatus of the present invention will be described by way of an example. In this example, two types of rod-like samples were collected from dentin at the center of the occlusal surface of the crown of a human third molar tooth. The two types of rod-like samples were taken from the dentin in which the major axes were respectively parallel and perpendicular to the running direction of the dentinal tubules. These samples were used for the tests after being stored in various conditions below:

Wet group: 23° C., immersed in a cell culture medium (HBSS);

Dry group: 23° C., stored in a desiccator at a relative humidity of 20% for 7 days; and

Heated groups: heated in an oven to 50° C., 70° C., 110° C., or 140° C. for 1 hour.

### Cantilever Bending Test

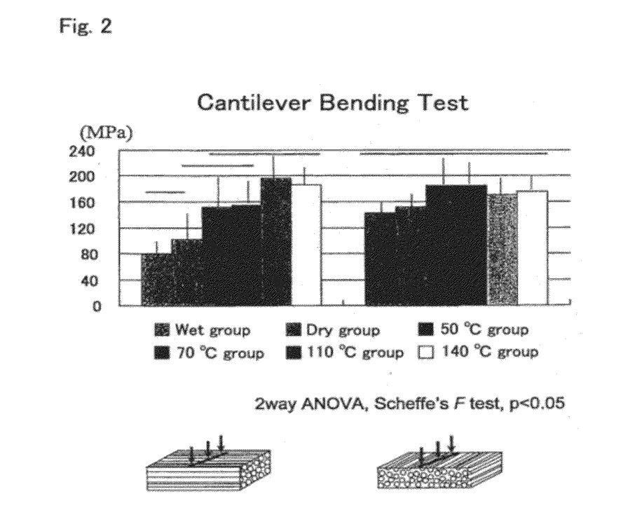

Two types of rod-like samples (1.7×0.9×8.0 mm) respectively parallel and perpendicular to the running direction of the dentinal tubules were used. Using a universal mechanical strength tester (Autograph AG-IS; manufactured by Shimadzu Corporation) in air at room temperature, the rod-like samples were held at a position 2 mm away from the end, a breaking load was applied at a crosshead speed of 0.1 mm/sec to a position 2 mm away from the held position (i.e., a position 4 mm away from the end on the side on which the rod-like samples were held), and the breaking load and the displacement amount at the yield point were measured. The measurement was performed on 10 to 15 samples in each group mentioned above. FIG. 2 shows the results regarding the breaking load at the yield point. The loading directions of the two types of parallel and perpendicular rod-like samples are shown at the bottom of FIG. 2, respectively. In the samples parallel to the running direction of the dentinal tubules, the bending strength was improved in all samples in the groups heated to the respective temperatures. The bending strengths of the samples in the group heated to 110° C. and the samples in the group heated to 140° C. were more than two times that of the wet group. On the other hand, in the perpendicular samples, the strengths of the samples in the heated groups tended to be improved slightly more than those of the other groups.

### Micro-Tensile Test

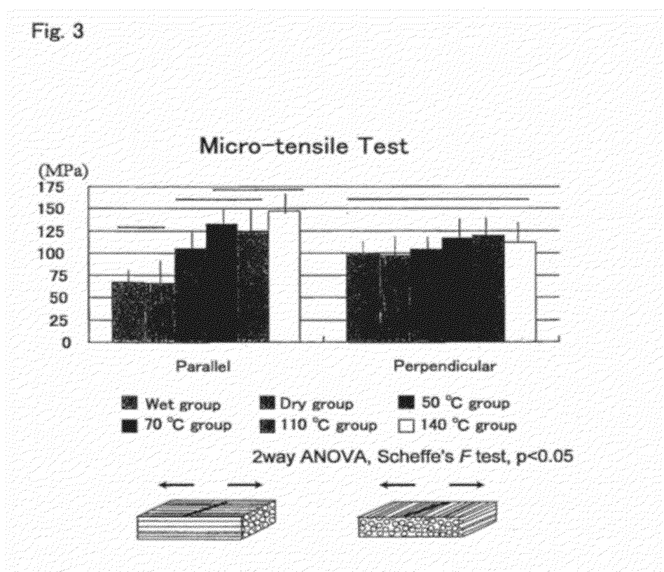

Two types of rod-like samples (1.0×0.5×8.0 mm) respectively parallel and perpendicular to the running direction of the dentinal tubules were used. Using a desktop mechanical strength tester (EZ Test; manufactured by Shimadzu Corporation) in air at room temperature, the samples were pulled from their both ends at a head speed of 0.1 mm/sec. The results are shown in FIG. 3. The tensile directions of the two types of parallel and perpendicular rod-like samples are shown at the bottom of FIG. 3, respectively. In the samples parallel to the running direction of the dentinal tubules, the strengths of the samples in the groups heated to 70° C. or higher were more than two times those of the samples in the wet group and the samples in the dry group. On the other hand, in the perpendicular samples, the strength was not improved well by heating.

Then, after platinum was evaporated on the fracture cross-sections of the samples in a freeze dryer (JFD-310; manufactured by JEOL Ltd.), the fracture cross-sections were observed using a scanning electron microscope (JSM-310; manufactured by JEOL Ltd.). In the samples parallel to the running direction of the dentinal tubules, the fracture cross-sections of the samples in the wet group were relatively flat, but the fracture cross-sections of the samples in the heated groups were rough (×5000: data is not shown).

### Fracture Toughness

Prenotches having a depth of approximately 40% of the sample thickness were formed at a point near the center of two types of rod-like samples (1.7×0.9×8.0 mm) respectively parallel and perpendicular to the running direction of the dentinal tubules. The samples having the prenotches were subjected to treatment using an electromagnetic-type micro-materials tester (MMT-101N; manufactured by Shimadzu Corporation) at sinewave: 2 Hz, R=1 and maximum load number: 5000 times, thereby causing crack extension. Then, a cantilever bending test was performed using the above-described universal mechanical strength tester (Autograph AG-IS; manufactured by Shimadzu Corporation) at a crosshead speed of 0.1 mm/sec. The fracture toughness (K value) of each sample was obtained using the following equation.

K=σ√(πa)·F(ab)

F(ab)=1.122−0.231(a/b)+7.33(a/b)²−13.08(a/b)³+14.0(a/b)

Here, σ indicates breaking stress (MPa), a indicates prenotch depth (mm), and b indicates sample thickness (mm).

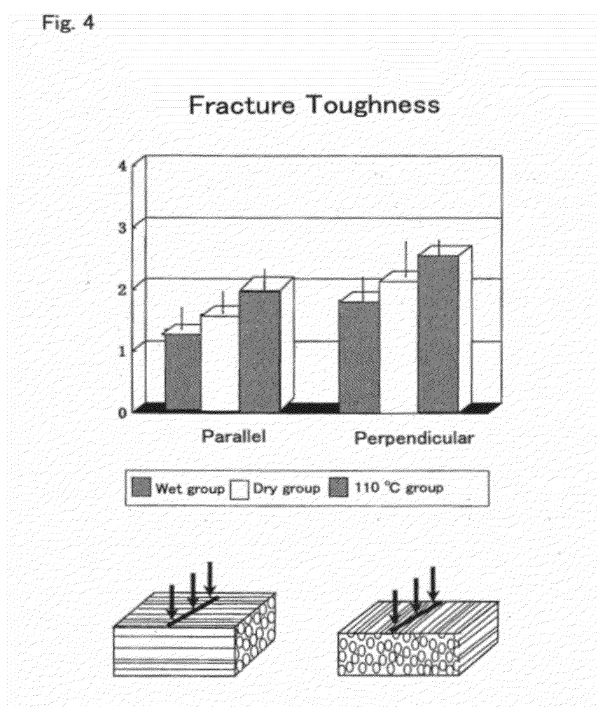

FIG. 4 shows the fracture toughnesses (K values) of the samples in the wet group, the samples in the dry group, and the samples in the group heated to 110° C. The loading directions of the two types of parallel and perpendicular rod-like samples are shown at the bottom of FIG. 4, respectively. The toughness of the samples in the group heated to 110° C. was higher than that of the samples in the wet group and the samples in the dry group.

### Elastic Modulus

The elastic modulus was obtained using the following equation based on the results of the cantilever bending test.

E=[(PL³)/3δI]·10⁻⁹

I=(bd³)/12

Here, E indicates elastic modulus (GPa), P indicates breaking load at yield point (N), L indicates effective distance (m), δ indicates displacement amount at yield point (m), I indicates cross-sectional secondary moment (m⁴), b indicates width (m), and d indicates thickness (m).

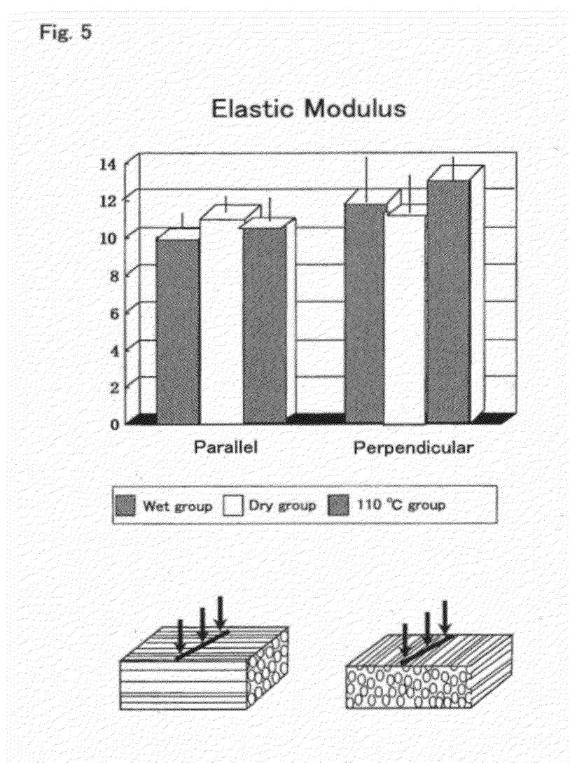

FIG. 5 shows the elastic moduli of the samples in the wet group, the samples in the dry group, and the samples in the group heated to 110° C. The loading directions of the two types of parallel and perpendicular rod-like samples are shown at the bottom of FIG. 5, respectively. There was no significant difference in elastic modulus between parallel and perpendicular samples. Based on these results, it was found that heating enhances the above-described various strengths, but does not change the elasticity.

### X-ray Diffraction Measurement

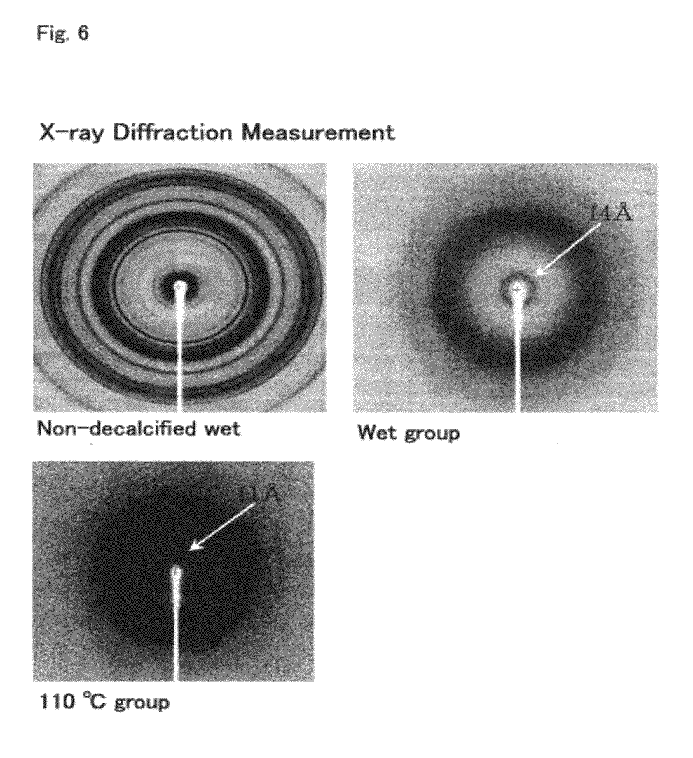

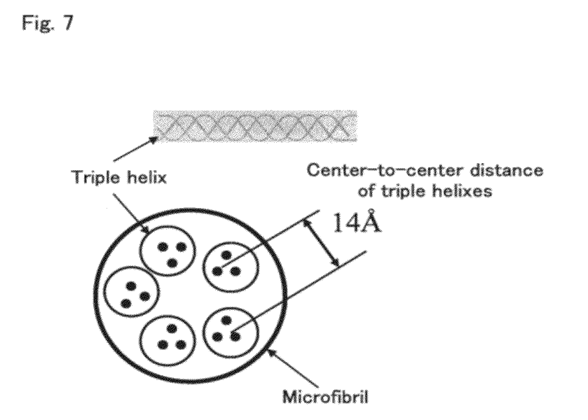

The samples in the groups were stored in 0.5M EDTA at 23° C. for 7 days, and subjected to a hydroxyapatite decalcification. Then, using an imaging plate X-ray detector (R-AXIS IV: manufactured by Rigaku Co.) equipped with an X-ray generator with rotating anodes (ultraX18: manufactured by Rigaku Co.), an X-ray diffraction measurement was performed at output: 50 kV, 250 mA, X-ray source: CuKα ray, beam size: 0.3 mm, and camera length: 70 mm. Here, for the sake of comparison, an X-ray diffraction measurement was performed also on wet samples before the decalcification. FIG. 6 shows X-ray diffraction photographs of the non-decalcified wet samples, the samples in the wet group, and the samples in the group heated to 110° C. In the samples in the decalcified wet group, a collagen-derived ring having a size of 14 Å was observed. On the other hand, in the samples in the group heated to 110° C., the size of this collagen-derived ring was reduced to 11 Å. Thus, the 14 Å of the collagen-derived ring refers to the center-to-center distance of collagen triple helixes (see FIG. 7), and it is found that heating reduced this distance to 11 Å.

Based on these results, it was found that heating to approximately 70° C. to 140° C. strengthened the structure around the dentinal tubules, and thus the strength of the entire dentin was improved.

### INDUSTRIAL APPLICABILITY

The present invention provides a dental apparatus that can safely and effectively reinforce a tooth from which the dental pulp has been removed. The apparatus of the present invention is useful for strengthening a tooth from which the dental pulp has been removed. With the apparatus of the present invention, a tooth that has become brittle due to the removal of dental pulp in the treatment of dental caries or the like can be easily strengthened, and the health of a tooth devoid of dental pulp can be maintained for a longer period of time. Accordingly, quality of life is improved. Furthermore, the dental apparatus of the present invention has a relatively simple structure including a commonly used heating probe and temperature sensor, so that this apparatus can be produced at a low cost and easily used. Thus, this dental apparatus is suitable for a wide range of applications.

1-11. (canceled)

12. A method for mechanically strengthening a tooth from which the dental pulp has been removed, comprising a step of heating the dentin of the tooth.

13. The method of claim 12, wherein the dentin of the tooth is heated so that a temperature of a surface of the dentin is 70° C. to 140° C.

14. The method of claim 12, wherein the heating step is performed using a dental apparatus comprising a dental pulp cavity-insertion plug.

15. The method of claim 14, wherein the dentin of the tooth is heated so that a temperature of a surface of the dentin is 70° C. to 140° C.

16. The method of claim 14, further comprising controlling the heating with a temperature-controlling means.

17. The method of claim 16, wherein the dental apparatus further comprises a handpiece portion and a control device,
wherein the handpiece portion comprises
a handgrip portion,
a protecting tube that is disposed at a front end of the handgrip portion and that partially projects from the front end of the handgrip portion, and the dental pulp cavity-insertion plug passes through the protecting tube so that a front end thereof is outside the protecting tube and a rear end thereof is accommodated in the handgrip portion,
a plug front end temperature-measuring means disposed at the front end of the plug,
a heating means for heating the plug accommodated in the handgrip portion, and
a heating switch disposed on the outer side of the handgrip portion;
the control device comprises a power on-and-off switch and the temperature-controlling means;
the plug front end temperature-measuring means and the heating switch are both connected to the temperature-controlling means, the temperature-controlling means is connected via the power on-and-off switch to the heating means;
and the method further comprises:
activating the heating means by the heating switch, and
controlling temperature of the heating means by the temperature control means based on a temperature measured by the plug front end temperature-measuring means.

18. The method of claim 17, wherein the dental apparatus further comprises a dentin surface temperature-measuring means connected to the temperature-controlling means, and the method further comprises controlling the temperature of the heating means also based on a temperature measured by the dentin surface temperature-measuring means.

19. The method of claim 17, wherein the temperature of the front end of the plug is set so that a temperature of a surface of the dentin is 70° C. to 140° C.

20. The method of claim 17, wherein the temperature of the front end of the plug is set to 70° C. to 500° C.

21. The method of claim 17, wherein the control device further comprises a plug temperature-display portion.

22. The method of claim 17, wherein the control device further comprises a dentin surface temperature-display portion.

23. The method of claim 17, wherein the heating means performs heating using an electric heater, electromagnetic waves, or laser beams.
